(19) United States
(12) Patent Application Publication
(10) Pub. No.: US 2025/0091251 A1
(43) Pub. Date: Mar. 20, 2025

(54) BACK GRIND ATTACHMENT AND KIT

(71) Applicant: NSI Solutions, Inc, Lynnwood, WA (US)

(72) Inventors: Kris Jorgensen, Lake Stevens, WA (US); Don Durand, Marysville, WA (US)

(21) Appl. No.: 18/886,828

(22) Filed: Sep. 16, 2024

Related U.S. Application Data
(60) Provisional application No. 63/538,329, filed on Sep. 14, 2023.

(51) Int. Cl. B28D 1/18

(52) U.S. Cl. CPC B28D 1/186; B28D 1/183

(57) ABSTRACT

A back grind attachment, kit and method used to make undercuts on a stone slab using a hand grinder. The attachment includes a mounting plate attached to a guide plate. e. Extending downward from the head is an arbor with one or more blades configured to form an undercut in the edge of the stone slab when pressed against the edge. The guide plate extends outward from said mounting plate and includes two wheels that roll against a fence formed on a fence plate. The mounting plate is pivotally attached to said guide plate, enabling it to rotate to one side, which allows the operator to rotate the grinder in an offset position and force the blades inward (deeper cut) or outward (shadow cut) from the edge of the stone slab. A clamping lever holds the mounting plate fixed over the guide plate. A uniform undercut is formed on the edge by simultaneously pushing the wheels against the fence and sliding the guide plate over the fence plate.

### CROSS-REFERENCE TO RELATED APPLICATIONS

This utility patent application is based on and claims the filing date benefit of U.S. provisional patent application (Application No: 63/538,329) filed on Sep. 14, 2023.

### FIELD AND BACKGROUND OF THE INVENTION

### Field of the Invention

This invention relates to tools for grinding natural or manmade stone products, specifically designed to create an undercut along the edge of the stone product.

### Background of the Invention

Undercuts are often made on the surface of a stone slab to allow the edge or surface of another stone slab or structure to tightly fit against it. They are commonly used to create hidden seams between two stone slabs. The undercut must be straight, parallel to the edge of the stone slab, and have a uniform width and depth. They are also used to create a rough or textured surface for an adhesive to bond effectively.

An undercut on a stone slab is usually made using a handheld grinder with a one or more cutting discs (called blades) stacked on the grinder's arbor. The task is very time-consuming, and the quality of the undercut varies depending on the operator's grinding skills.

There is a need for a back grind attachment that can be attached to a standard handheld grinder that enables an operator to quickly make different size undercuts on a stone slab that are straight, parallel to an edge on the stone slab, and has a uniform width and depth.

### SUMMARY OF THE INVENTION

The above objective is met by the back grind attachment disclosed herein. The attachment is configured to selectively attach to a standard electric or air-powered, handheld grinder/polisher, herein called a ‘grinder’. When assembled and attached, it forms an undercut-forming tool that is used with an elongated fence plate mounted over the surface of a stone slab. The fence plate is a flat elongated, rectangular structure with two outer edges and a raised lip (called a fence) that extends the entire length of the fence plate and parallel to the front edge. During use, the fence plate is securely mounted to the top surface of a stone slab with front edge positioned just inside and parallel to the outer edge of the stone slab to be ground. The fence extends upward from the fence plate and parallel to the stone slab's edge.

The grinder includes a grinder body containing a motor. The grinder body includes a head with an arbor coupled to the motor. The grinder body is held horizontally during use, and the arbor extends perpendicular downward from the head. Heads on different grinder bodies may use different hole configurations formed on the bottom surface of the head. The head may be directly attached to a mounting plate, discussed further below, or it may be attached to an intermediate structure called an adapter plate that connects the head of the grinder to the mounting plate. When an adapter plate is required, suitable threaded connectors are used to attach the adapter plate to the head and to the mounting plate.

The mounting plate includes a rear section that attaches to the head of the grinder or to an adapter plate, and a front section that extends forward from the rear section. Attached to the front section of the mounting plate is a guide plate with two wheels mounted on the guide plate's front section. A handle is attached to the top surface of the guide plate, which the operator uses to force the tool inward and to slide the tool back and forth over the fence plate. The two wheels on the guide plate have a sufficient diameter, so the outer surface of each wheel extends beyond the front edge of the guide plate and contacts the rolling surface on the fence.

During use, the operator activates the motor on the grinder and grips the handle, and positions the two wheels against the fence. While holding the guide plate horizontally over the fence plate so that the two wheels continuously press against the fence, the operator then slides the grinder longitudinally in one direction or back and forth over the fence plate.

When the mounting plate and guide plate are axially aligned and the two wheels are pressed against the fence, the grinder body extends outward from the slab's outer edge. An important feature of the invention is the rotational movement of the mounting plate over the guide plate. The mounting plate and guide plate are pivotally connected via an offset pivot pin, which enables the edge of the mounting plate opposite the pivot pin aligned with the guide plate or swing outward (towards the edge of the slab) in a 0 to 15-degree arc. A clamping lever is provided that when rotated, locks the two plates together. During use, the clamping lever may be loosened, enabling one edge of the mounting plate to swing or rotate outward thereby changing the angle of the grinder's body relative to the fence plate. By changing the angle of the grinder body relative to the fence plate, the operator can finely move the tips of the blades mounted on the grinder's arbor inward and against the slab's outer edge. By decreasing the angle between the mounting plate and the guide plate, the blades are forced into the outer edge of the slab. When the grinder is set at an angle relative to the fence plate to produce an undercut with the desired depth, a clamping lever is then tightened to lock the mounting plate at a fixed angle on the guide plate.

Formed on the top surface of the mounting plate are optional markings that the operator used to align the front edge of the mounting plate to the guide plate.

During use, the bottom of the mounting plate must slide freely and smoothly over the top surface of the fence plate. An optional low-friction, flat rub plate may be mounted on the bottom of the guide plate to reduce friction.

It is well known that water is sprayed on a stone surface to reduce dust, reduce heat, reduce chipping, and increase visibility. An optional water valve, water nozzle, and splash shield are attached to the mounting plate.

As stated above, the depth of the undercut is controlled by adjusting the angular position of the mounting plate on the guide plate. The vertical distance or position or height of the undercut may be controlled by changing the number of blades attached to the grinder's arbor. A kit is disclosed herein, that may include the adapter plate, the fence plate and/or a plurality of replaceable blades and spacers configured to mount on the grinder's arbor. During use, the operator may change the number of blades and spacers to adjust the position or height of the undercut in the stone slab.

Using the back grind attachment on a slab with a guide plate temporarily mounted on the slab's surface with the fence plate's fence aligned parallel to the edge to be ground, a method for forming a uniformly shaped undercut on the edge is taught.

### BRIEF DESCRIPTION OF DRAWINGS

FIG. 1 is a top perspective view of the back grind tool mounted on a stone slab.

FIG. 2 is a top plan view of the back grind tool and stone slab shown in FIG. 1.

FIG. 3 is a side elevation view of the back grind tool and stone slab shown in FIG. 1.

FIG. 4 is a top perspective view of the hand grinder and undercut attachment.

FIG. 5 is a left-side elevation view of the hand grinder and back grind attachment shown in FIG. 4.

FIG. 6 is a bottom perspective view of the hand grinder and the back grind attachment shown in FIG. 4.

FIG. 7 is a front elevation of the hand grinder and the back grind attachment shown in FIG. 4.

FIG. 8 is a top plan view of the mounting plate.

FIG. 9 is a bottom plan view of the mounting plate.

FIG. 10 is a left-side elevational view of the mounting plate.

FIG. 11 is a top plan view of the guide plate

FIG. 12 is a front elevational view of the guide plate.

FIG. 13 is a right-side elevational view of the guide plate.

FIG. 14 is a side elevational view of a modified fence plate with an angled fence and angled edge wheels used in place of straight edge wheels.

### DETAILED DESCRIPTION OF THE INVENTION

A back grind attachment 22 for a handheld grinder/polisher 18 (hereinafter called a grinder 18) creates a back grind or undercut 10 in the edge 8 of the stone slab 4.

When the back grind attachment 22 is attached to a grinder 18, the combined tool is designed to be used with a flat, elongated fence plate 12 mounted over the top surface 6 of a stone slab 4. The fence plate 12 includes two parallel, longitudinal outer edges 13, 14, and a flat top slide surface 15. In one embodiment of the fence plate, a fence plate 16 with a vertical rolling surface is used. The fence plate 16 is aligned over the top surface 5 of slab 8 so that the outer edges 13 and 14 and the vertical rolling surface of fence 16 are parallel to outer edge 8. During use, two or more clamps (not shown) temporarily hold fence plate 12 on the top surface 6 of a stone slap 4.

Grinder 18 includes a grinder body 19 containing an electric or air-powered motor (not shown). Grinder body 19 includes a head 20 with an arbor 21 coupled to the motor. The arbor 21 is perpendicularly aligned to the grinder's longitudinal axis and extends downward from the bottom surface of the head 20. One or more cutting blades 62 are aligned in a stack 60 on the arbor 21. Optional spacers may also be attached to arbor 21 as needed. When grinding an outer edge 8 on a slab 4, the operator holds the grinder body 19 horizontally and forces the tips of the blades 62 against the outer edge 8.

The back grind attachment 22 is configured to attach to different manufacturers' electric or air-powered grinders 20. Attached to the grinder's head 20 is a flat, thin, replaceable adapter plate 23 with mounting holes 24 compatible with the mounting bolts used in the grinder head 20. The hole pattern used to connect the adapter plate 23 to the head 20 can vary between manufacturers. To use a specific type of attachment with a grinder 18, an adapter plate 23 compatible with the attachment and head 20 must be used. Threaded connectors 26 extend through the holes 24 to attach the adapter plate 23 to the bottom on the head 20. Also formed on adapter plate 23 is a large center hole 25 that receives the neck (not shown) formed on the head 20.

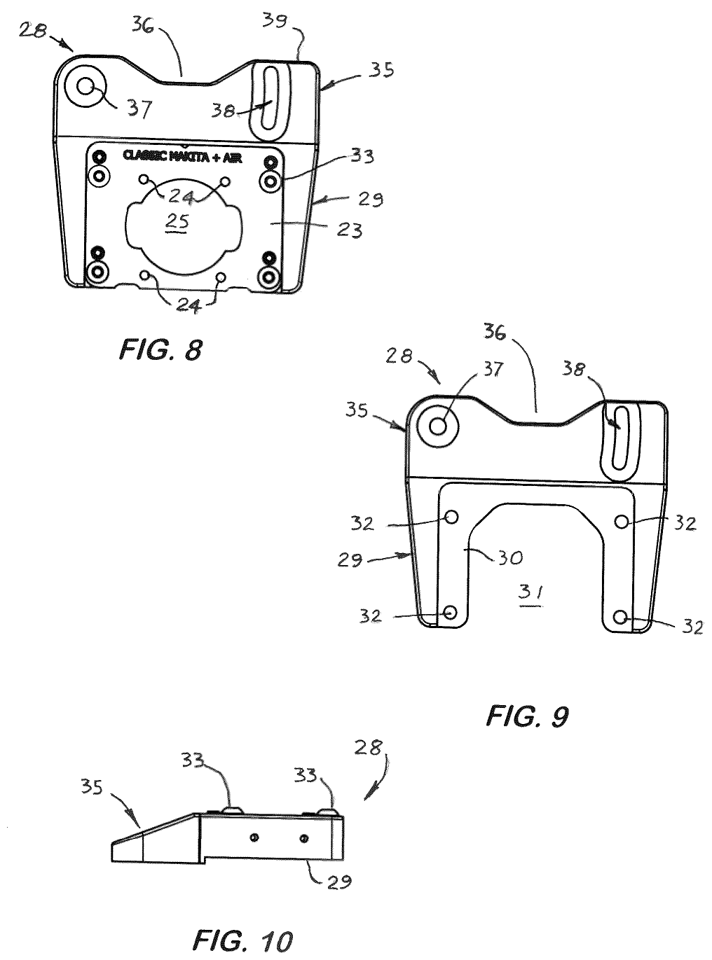

Attached to adapter plate 23 is a mounting plate 28 shown more clearly in FIGS. 8-10. The mounting plate 28 is a u-shaped structure with a rear section 29 that includes a recessed flat cavity 30 configured to receive the adapter plate 23. The mounting plate 28 also includes a sloped front section 35. Formed on the rear section 29 is a large center hole 31 that receives the end of the neck extending downward from the grinder's head 20. Formed in the recessed cavity 30 and surrounding the center hole 31 are a plurality of mounting holes 32 that received threaded connectors 33 that extend downward from the adapter plate 23. The threaded connectors 33 attach mounting plate 28 to adapter 23.

The front section 35 of the mounting plate 28 extends forward from the rear section 29. Formed on the front edge of the front section 35 is a cutout region 36. Formed on opposite sides of the front section 35 is a pivot pin hole 37 and curved slot 38. The rear edge of the guide plate's front section 42 extends rearward and is complementary to the cutout region 36 formed on the mounting plate 28.

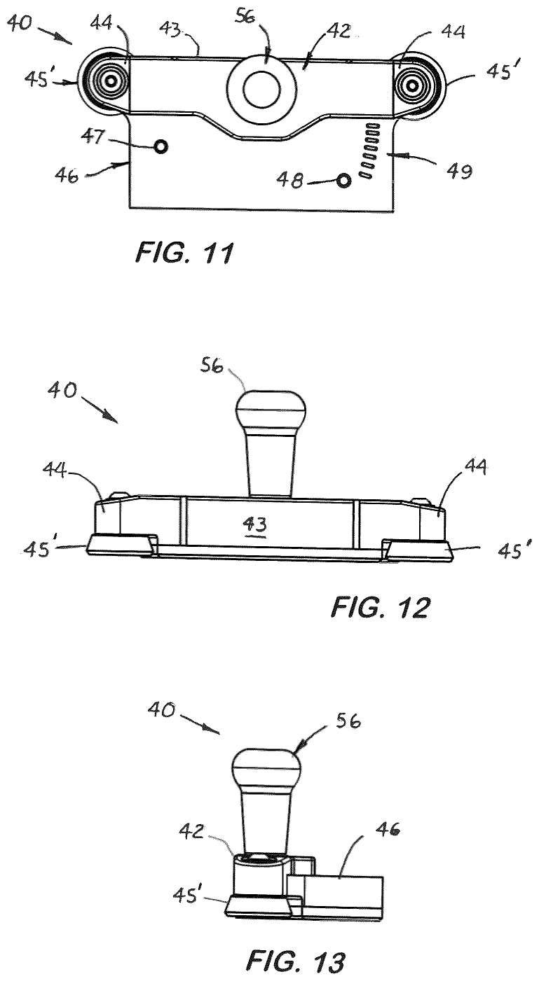

Attached to the front section 35 of the mounting plate 28 is a guide plate 40, shown more clearly in FIGS. 11-13. The guide plate 40 is rectangular with an elevated front section 42 and a lower rear section 46. The rear section 46 of the guide plate 40 is configured to slide under the front section 35 on the mounting plate 28. Formed on the rear section 46 is a pivot pinhole 47 and a clamping arm hole 48. The pivot pinhole 47 is aligned and registered with the pivot pin hole 37 on the mounting plate 28. The threaded clamping lever hole 48 is aligned and registered with the curved slot 38 formed on the mounting plate. During assembly, holes 37 and 47 are aligned and curved slot 38 is aligned over hole 48. A pivot pin 51 is inserted into them to pivotally attach the mounting plate 28 to the guide plate 40. A threaded clamping lever 54 is inserted into curved slot 38 and connects to hole 48. By loosening the clamping lever 54, the mounting plate 28 can rotate over the rear section 46 of guide plate 40. By tightening the clamping lever 54, the mounting plate 28 is fixed over the rear section 46 of the guide plate 40.

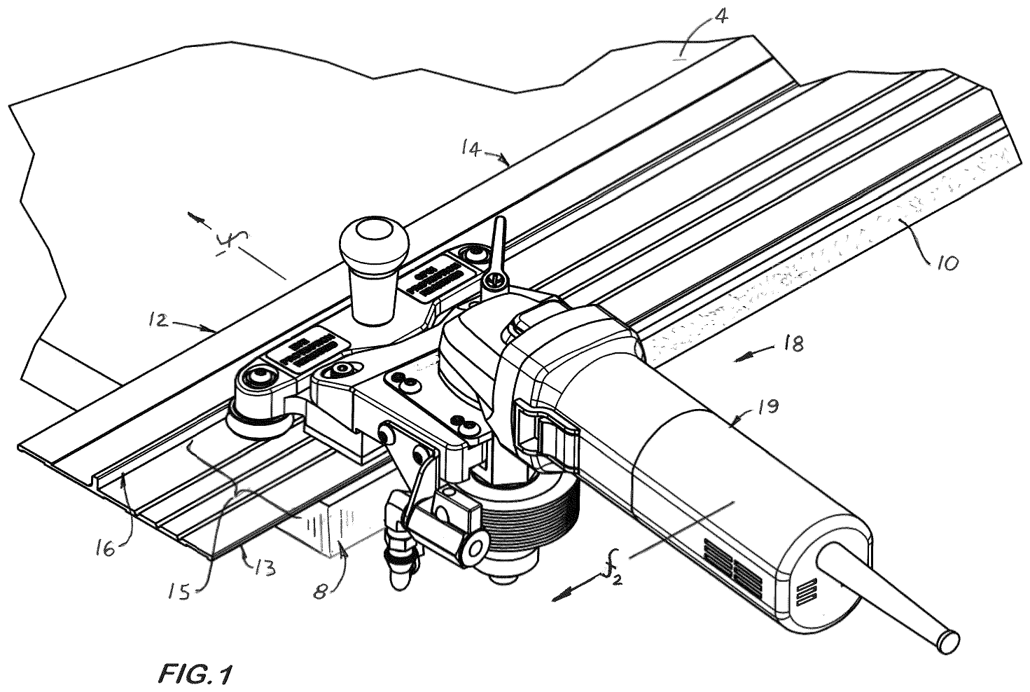

The front section 42 has a straight front edge 43 and two opposite ears 44. Attached to each ear 44 is a wheel 45 that rotates freely. During use, the bottom surface of the rear section 46 is positioned over the slide surface 15 formed on the fence plate. When the guide plate 40 is forced inward, the diameter of each wheel 45 is sufficient so that two wheels 45 press against fence 16. Attached to the guide plate 40 is a vertical handle 56. When the guide plate 40 is forced inward (see f1 in FIG. 1), the two wheels 45 are forced against the fence 16 and the operator simultaneously uses the handle 56 and uses a second force (f2 in FIG. 1) to slide the combined attachment 22 and grinder 18 longitudinally over the fence plate 12 Attached to the bottom surface of the rear section 46 is a rub plate 59 that reduces friction.

Formed on the rear section 46 is a pivot pinhole 47 and a clamping arm hole 48. The pivot pinhole 47 is aligned and registered with the pivot pinhole 37 on the mounting plate 28. The threaded clamping arm hole 48 is aligned and registered with the curved slot 38 formed on the mounting plate. During assembly, pinholes 37 and 47 are aligned and curved slot 38 is aligned over hole 48. A pivot pin 52 is inserted into them to pivotally attach the mounting plate 28 to the guide plate 40. A threaded clamping lever 54 is inserted into curved slot 38 and connects to hole 48. Clamping lever 54 is loosened which allows the mounting plate 28 to rotate over the guide plate 40, or tightened to lock the mounting plate 28 is a fixed position over the guide plate 40.

Also formed on the top surface of the guide plate 40 are optional alignment markings 49. The markings 49 are in an open area between the front section 35 of the mounting plate 28 and the rear section 46 on the guide plate. When assembled, the markings 28 can be aligned with the front edge 39 of the front section 35 of the mounting plate 28. During use, the operator rotates mounting plate 28 over guide plate 40 and aligns the front edge 39 of the front section 35 of the mounting plate 28 with one of the markings 49. As the entire tool slides back and forth over fence plate 12, the operator can monitor the front edge 39 of the front section 35 for rotational movement of the mounting plate 28 over guide plate 40.

Also mounted on the side of the mounting plate 28 is a vertical bracket 65. Attached to bracket 65 is a water valve 66 connected to nozzle 68. During operation, a water hose (not shown) is attached to the water valve 66, which delivers water to the nozzle 68 and spays water to the outer edge 8. Also attached to the mounting plate 28 opposite bracket 65 is an optional splash shield 70.

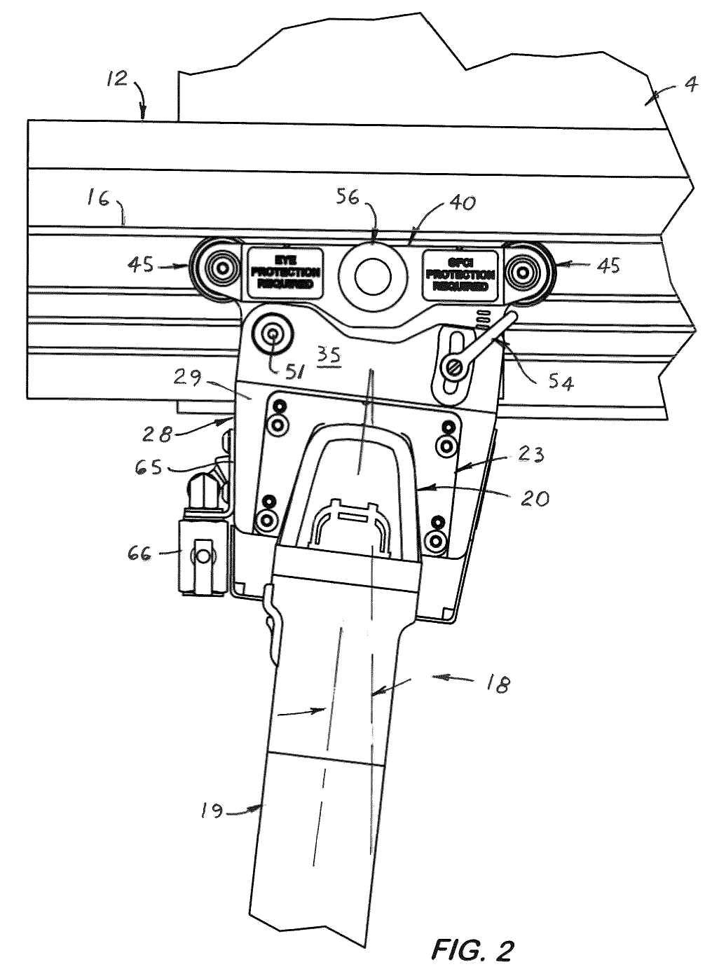

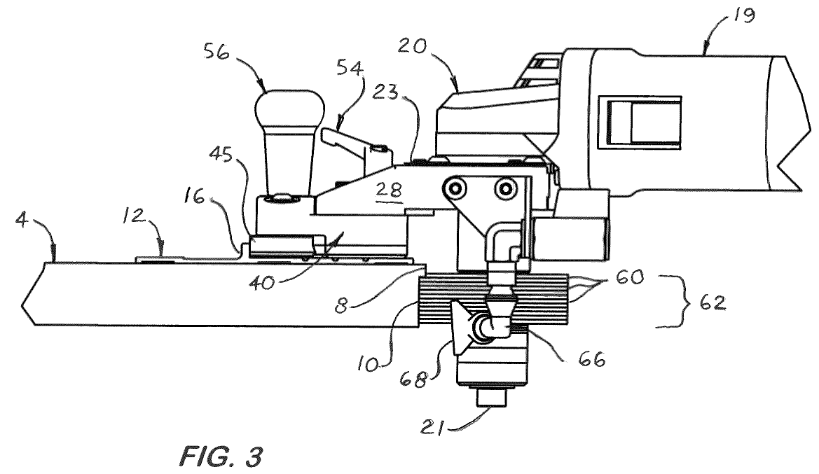

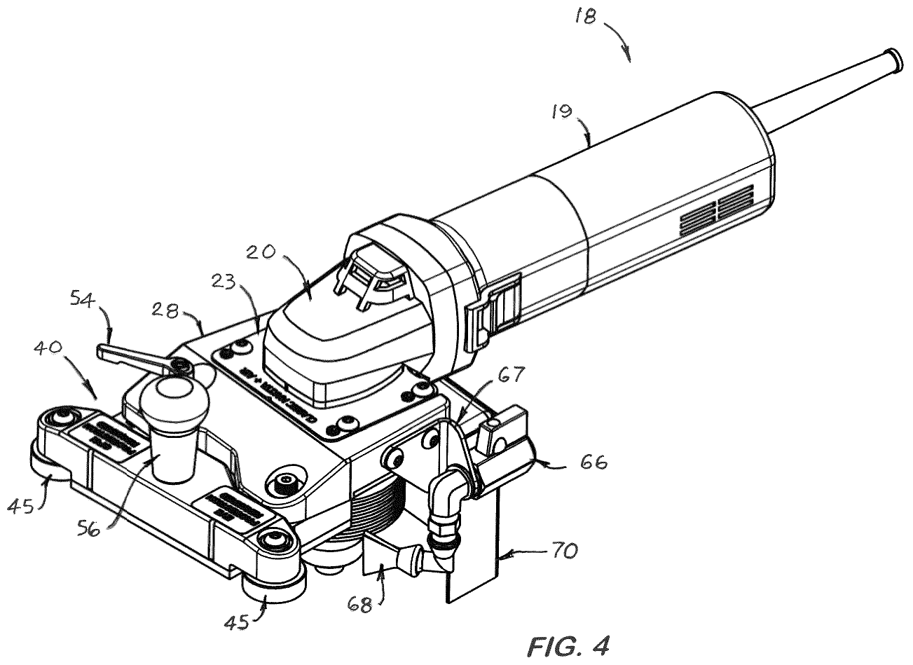

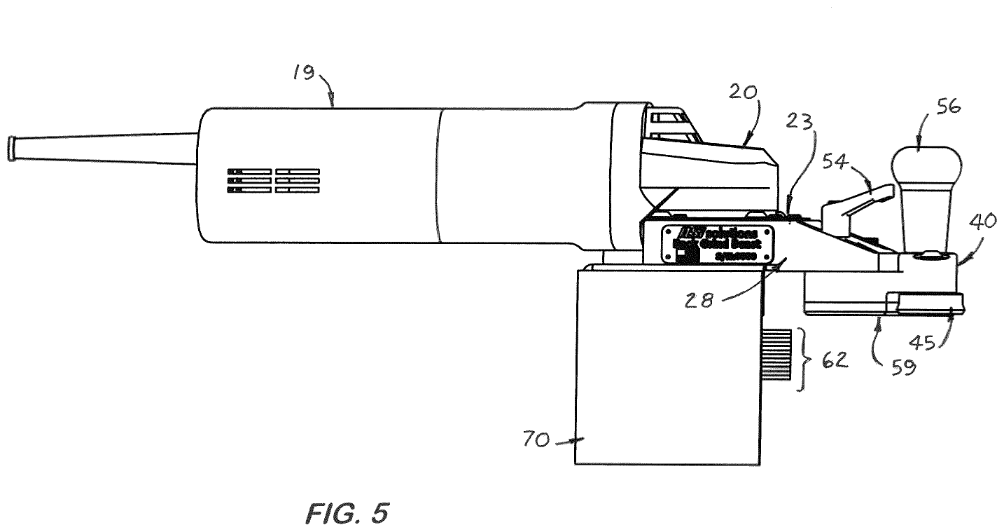

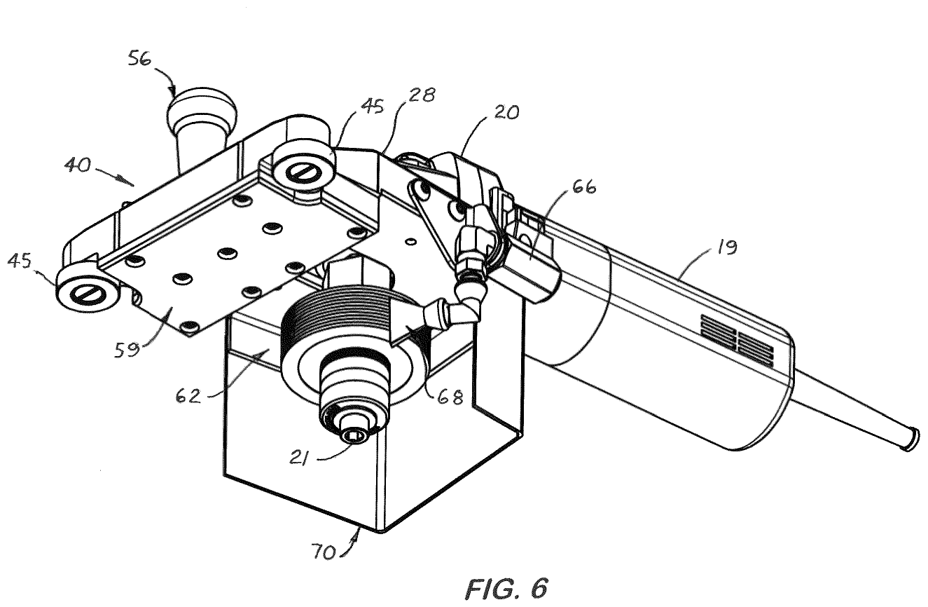

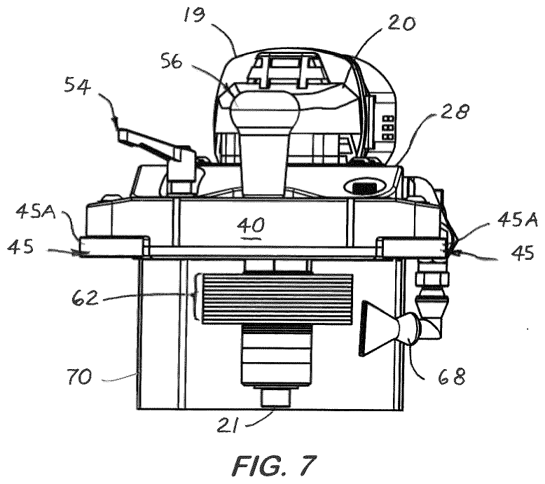

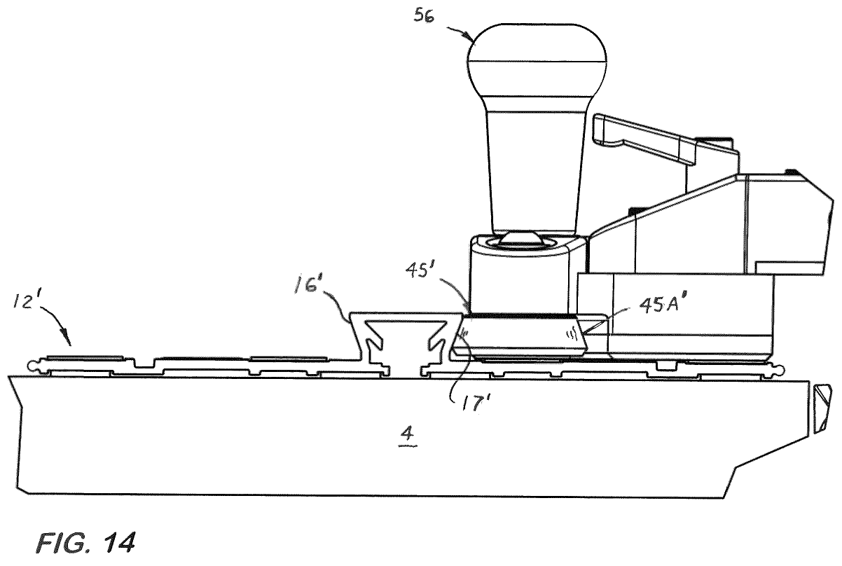

FIGS. 1-3 show the grinder 18 and the attachment 22 used on a fence plate 12 with a vertical fence 16. The wheels 45 on the guide plate 40 each have a vertical outer edge 45A that rolls against the vertical rolling surface 17 on an upward extending fence 16. FIG. 14 is a side elevational view of a modified fence plate 12′ with a fence 16′ with an angled rolling surface 17′ and the back grind attachment with a guide plate 40 with wheels 45′ with angled outer surfaces 45A′. FIGS. 11, 12 and 13 also show the guide plate 40 with wheels 45′.

### Various Kit Configurations:

The back grind attachment 22 is a grinder accessory with an adapter plate 23, a mounting plate 28 and a guide plate 40. Attachment 22 may be distributed as a kit with other components, such as the fence plate 12 or 12′ with a fence 16 or 16′, respectively, compatible with the wheels 45 and 45′ used on the guide plate 40. Attachment 22 may also be distributed with different adapter plates 23 and hole patterns compatible with the heads on different grinders.

### Operation:

During use, a fence plate 12 is attached to the top surface of a stone slab 4. The fence plate 12 is positioned on the top surface so that fence 16 is aligned parallel to the stone slab's outer edge 8. A grinder 18 with a compatible adapter plate 23 attached to the grinder's head 20 is then attached to the mounting plate 28. Guide plate 40 was previously attached to mounting plate 28, and the mounting plate 28 were then placed over slide surface 15 on the fence plate 12. The grinder body 19 and handle 56 are manually forced inward, forcing both wheels 45 on the front section 42 of the guide plate 40 against the fence 16. When the wheels 45 are pressed against the fence 16, and the mounting plate 28 is axially aligned with the guide plate 40, the grinder body 19 extends outward from the slab's outer edge 8. The outer edge 8 is tangent to the tips of the blades 62 in the blade stack 60 attached to the grinder's arbor 21.

By rotating the mounting plate 28 over guide plate 40, the grinder body 19 is offset from the outer edge 8, and the tips of the blades 62 cut into the outer edge 8. Because the pivot pin 51 is offset on the mounting plate 28 and on the guide plate 40, the length of the curve slot 38 on the mounting plate 28 is sufficient to allow the mounting plate 29 to rotate in a 0 to 15-degree arc around the pivot pin 51. Rotation of mounting plate 28 over guide plate 40 causes the grinder body 19 to rotate. By reducing the angle, the tips of the blades 62 in the blade stack 60 are forced inward to the outer edge 8 thereby making a deeper cut. The depth of the cut formed depends also in part on the diameter of the blades attached to the grinder. For three-inch blades 62, the depth of the cut can vary from 0 (‘15’ degree marking) to 4 mm (‘O degree marking)’ When the grinder 18 is set at a desired angle to form the desired undercut 10, the clamping lever 54 is then tightened to lock the mounting plate 28 at a fixed angle on the guide plate 40.

During use, the operator can continuously activate and move grinder 18 back and forth over the fence plate 12. If the depth of the undercut 10 needs to be increased, the operator loosens the clamp lever 54 and decreases the angle of the mounting plate 28 over the guide plate 40.

In summary, the depth of the undercut 10 on the outer edge 8 of a stone slab 4 is controlled by adjusting the angular position of the mounting plate 28 on the guide plate 40. The vertical distance of the undercut 10 may be controlled by changing the number and position of blades 60 on the arbor 21.

In compliance with the statute, the invention described has been described in language more or less specific as to structural features. It should be understood, however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

We claim:

1. A back grind attachment for a hand grinder used to make an undercut on the edge of a stone slab with a fence plate mounted on the top surface and adjacent to an edge of said stone slab, said fence plate includes a straight edge, a slide surface and a longitudinally aligned upward extending fence, said hand grinder that includes a grinder body, a motor located inside said grinder body, a head, and arbor coupled to said motor and extending perpendicularly from said head, and one or more blades attached to said arbor used to form a undercut in said stone slab, said back grind attachment comprising:
a. a mounting plate attached to and extending forward from said head, said mounting plate includes a center axis, a front edge, a first lateral edge and a second lateral edge:
b. a guide plate extending forward from the said mounting plate, said guide plate includes a longitudinal axis and two wheels spaced apart and aligned with said longitudinal axis;
c. a pivot pin connected to said guide plate, said pivot pin extends upward through mounting plate at an offset location thereby enabling said mounting plate to rotate over said guide plate; and,
d. a clamping lever configured to lock said mounting plate at a fixed location over said guide plate.

2. The back grind attachment, as recited in claim 1, further includes a plurality of markings located between said mounting plate and said guide plate that indicates the angle said mounting plate is positioned to said guide plate.

3. The back grind attachment, as recited in claim 1, further includes a rub plate attached to said guide plate.

4. The back grind attachment, as recited in claim 1, further includes a water valve and water nozzle attached to said mounting plate.

5. The back grind attachment, as recited in claim 4, further includes a spray shield attached to said mounting plate.

6. The back grind attachment, as recited in claim 1, wherein said clamping lever includes a rotating post and a handle attached to said post, said post being attached to said guide plate and extending through a curved slot formed on said mounting plate.

7. The back grind attachment, as recited in claim 6, further includes a rubbing plate attached to the said guide plate.

8. The back grind attachment, as recited in claim 5, further includes a plurality of markings located between said mounting plate and said guide plate that indicates the angle said mounting plate is positioned to said guide plate.

9. The back grind attachment, as recited in claim 3, further includes a water valve and water nozzle attached to said mounting plate.

10. The back grind attachment, as recited in claim 6, further includes a water valve and water nozzle attached to said mounting plate.

11. The back grind attachment, as recited in claim 1, further includes a spray shield attached to said mounting plate.

12. The back grind attachment, as recited in claim 7, further includes a spray shield attached to the mounting plate.

13. The back grind attachment, as recited in claim 1, wherein said fence on said fence plate has a vertical rolling surface, and each said wheel has a vertical outer edge configured to roll against said vertical rolling surface.

14. The back grind attachment, as recited in claim 1, wherein said fence on said fence plate has an angled rolling surface and each said wheel has an angled outer edge configured to roll against said angled rolling surface.

15. The back grind attachment, as recited in claim 1, further includes an adapter plate located between the head of said grinder and said mounting plate.

16. The back grind attachment, as recited in claim 6, further includes an adapter plate located between the head of said grinder and said mounting plate.

17. A method of forming an undercut on the edge of a stone slab using a guide plate with a longitudinal aligned fence with a rolling surfacing and a sliding surface, said guide plate being temporarily attached to said stone slab so that said rolling surface on said fence is parallel to said edge, said method comprises the following steps:
a. selecting a grinder with a grinder body, a head attached to said grinder body, an arbor extending downward from said head, and at least one or more blades attached to said arbor configured to form said undercut;
b. selecting a back grind attachment that includes, a mounting plate and a guide plate, said guide plate extending forward from said mounting plate and includes a sliding surface configured to slide over said glide surface on said fence plate, said guide plate also includes two wheels configured to roll over said fence, said back grind attachment also includes a pivot pin attached to said guide plate and extends upward through said mounting plate at an offset location thereby enabling said mounting plate to rotate over said guide plate and a clamping lever configured to lock said mounting plate at a fixed location over said guide plate;
c. attaching said mounting plate to said head of said grinder;
d. positioning said guide plate over said fence plate so that said wheels are positioned against said fence;
e. rotating said mounting plate on said guide plate so that said blade on said arbor is positioned to cut an undercut on said edge of said stone slab at a desired depth;
f. locking said mounting plate in a fixed position over said guide plate;
g. activating said motor; and,
h. simultaneously pushing said wheels against said fence and sliding said guide plate over said sliding surface on said fence plate to form an undercut on said edge of said stone slab.
